(19) United States
(12) Patent Application Publication
(10) Pub. No.: US 2007/0238049 A1
(43) Pub. Date: Oct. 11, 2007

(54) PLANOGRAPHIC PRINTING PLATE MATERIAL AND PRINTING PROCESS

(75) Inventor: Hidetoshi Ezure, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/697,539

(22) Filed: Apr. 6, 2007

(30) Foreign Application Priority Data
Apr. 11, 2006 (JP) JP2006-108403

(51) Int. Cl. G03C 1/00

(52) U.S. Cl. 430/270.1; 101/454

(57) ABSTRACT

Disclosed is a planographic printing plate material comprising a support and provided thereon, a hydrophilic layer containing a light-to-heat conversion material and a thermosensitive image formation layer in that order, wherein the thermosensitive image formation layer contains a latex containing a hydrophobic component and a hydrophilic component as a protective colloid.

This application is based on Japanese Patent Application No. 2006-108403 filed on Apr. 11, 2006 in Japanese Patent Office, the entire content of which is hereby incorporated by reference.

### FIELD OF THE INVENTION

The present invention relates to a planographic printing plate material and a printing process, and particularly to a planographic printing plate material capable of forming an image according to a computer to plate (CTP) system and a printing process employing the planographic printing plate material.

### BACKGROUND OF THE INVENTION

In recent years, printing employing a CTP system has been conducted in printing industries, accompanied with the digitization of printing data. A printing plate material for CTP, which is inexpensive, can be easily handled, and has a printing ability comparable with that of a PS plate, is required.

A versatile processless printing plate has been sought, which has a direct imaging (DI) property not requiring any development employing a specific developer, can be applied to a printing press with a direct imaging (DI) function, and can be handled in the same manner as in PS plates.

A thermal processless printing plate material is imagewise exposed employing an infrared laser with an emission wavelength of from near-infrared to infrared regions to form an image. The thermal processless printing plate material employing this method is divided into two types; an ablation type printing plate material and an on-press development type printing plate material with a heat melting image formation layer.

Examples of the ablation type printing plate material include those disclosed in for example, Japanese Patent O.P.I. Publication Nos. 8-507727, 6-186750, 6-199064, 7-314934, 10-58636 and 10-244773.

These references disclose a printing plate material comprising a support, and provided thereon, a hydrophilic layer and a lipophilic layer, either of which is an outermost layer. When a printing plate material is imagewise exposed in which the hydrophilic layer is an outermost layer, the hydrophilic layer is removed by ablation to reveal the lipophilic layer, whereby an image is formed. This printing plate material has problem that the exposure device used is contaminated by the ablated matter, and a special suction device is required for removing the scattered material. Therefore, this printing plate material is low in versatility to the exposure device.

A printing plate material has been developed which is capable of forming an image without ablation, and does not require development treatment employing a special developer or wiping-off treatment.

There is, for example, a printing plate material for CTP as disclosed in Japanese Publication Nos. 2938397 and 2938397, which comprises a thermosensitive image formation layer containing thermoplastic particles and a water-soluble binder and which is capable of be developed with a dampening solution or printing ink on a printing press. The printing plate material, capable of being subjected to on-press development, provides an image with sharp dot forms and high precision, and does not require a conventional development process after imagewise exposure, eliminating environmental problems.

However, the printing plate material has problems in that strength of the hydrophilic layer and thermosensitive image formation layer is poor, resulting in low printing durability. In order to overcome the problems, a method is proposed which incorporates reactive thermoplastic resins into the thermosensitive image formation layer (see for example, Japanese Patent O.P.I. Publication Nos. 2005-297223 and 2005-305690.).

However, the incorporation of the reactive thermoplastic resins into the thermosensitive image formation layer lowers development property and tends to produce stain, particularly stain at non-image portions due to scratches. The printing plate material is strongly desired which has high printing durability, excellent development property and high stain resistance.

There is known a printing plate material, comprising an image formation layer containing microcapsules enclosing a polymerizable compound, which produces no ablation and is capable of being subjected to on-press development (see for example, Japanese Patent O.P.I. Publication No. 2001-277740.). There is known a printing plate material, capable of being subjected to on-press development, which comprises a support and provided thereon, a light sensitive layer containing an infrared absorbing agent, a polymerization initiator and a polymerizable compound (see for example, Japanese Patent O.P.I. Publication No. 2002-365789.).

In order to improve printing durability, development property and stain resistance of the printing plate material as described above, a method is proposed which employs a subbing layer containing a specific water-soluble resin between the support and the image formation layer. However, it has proven that when printing is carried out employing a powdering system, such a method has problems in that printing durability is not sufficient, and development property and stain resistance deteriorate which results from the presence of the polymerizable compound.

### SUMMARY OF THE INVENTION

Accordingly, an object of the invention is to provide a planographic printing plate material for a CTP system which is excellent in on-press development property, printing durability, and stain resistance, particularly stain resistance (scratch resistance) at non-image portions due to scratches.

### DETAILED DESCRIPTION OF THE INVENTION

The above object of the invention can be attained by any one of the following constitutions.

1. A planographic printing plate material comprising a support and provided thereon, a hydrophilic layer containing a light-to-heat conversion material and a thermosensitive image formation layer in that order, wherein the thermosensitive image formation layer contains a latex containing a hydrophobic component and a hydrophilic component as a protective colloid.

2. The planographic printing plate material of item 1 above, wherein the hydrophobic component is comprised of heat melting particles or heat fusible particles.

3. The planographic printing plate material of item 2 above, wherein the hydrophobic component is comprised of the heat melting particles, which are formed from a wax material having a softening point of from 40 to 120° C. and a melting point of from 60 to 150° C.

4. The planographic printing plate material of item 3 above, wherein the wax material is selected from the group consisting of polyethylene wax, microcrystalline wax, fatty acid ester wax and fatty acid wax.

5. The planographic printing plate material of item 2 above, wherein the hydrophobic component is comprised of the heat melting particles, which are formed from a hydrophobic polymer having a weight average molecular weight of from 500 to 500,000 and a number average molecular weight of from 200 to 600,000.

6. The planographic printing plate material of item 5 above, wherein the hydrophobic polymer is selected from the group consisting of (meth)acrylate (co)polymer, (meth)acrylic acid (co)polymer, vinyl ester (co)polymer, polystyrene and the synthetic rubbers.

7. The planographic printing plate material of any one of items 1 through 6 above, wherein the hydrophilic component as a protective colloid is selected from the group consisting of polyvinyl alcohol and its derivatives, polyacrylic acid and its derivatives, polystyrene sulfonic acid and its derivatives, and gelatin.

8. The planographic printing plate material of any one of items 1 through 7 above, wherein the content ratio (by weight) of the hydrophobic component to the hydrophilic component in the latex is from 90/10 to 50/50.

9. The planographic printing plate material of any one of items 1 through 8 above, wherein the thermosensitive image formation layer contains an infrared absorbing dye.

10. The planographic printing plate material of any one of items 1 through 9 above, wherein the thermosensitive image formation layer is capable of being subjected to on-press development.

11. A printing process comprising the steps of a) imagewise exposing the planographic printing plate material of any one of claims 1 through 10 above, employing a laser; and b) developing the exposed planographic printing plate material on the plate cylinder of a printing press by supplying dampening water or both dampening water and an printing ink to the exposed planographic printing plate material to prepare a planographic printing plate, followed by printing.

The invention will be explained in detail below.

The planographic printing plate material of the invention comprises a support and provided thereon, a hydrophilic layer containing a light-to-heat conversion material and a thermosensitive image formation layer (hereinafter also referred to simply as an image formation layer) in that order, wherein the thermosensitive image formation layer contains a latex (hereinafter also referred to as the latex in the invention) containing a hydrophobic component and a hydrophilic component as a protective colloid. Herein, the hydrophobic component is protected by the protective colloid.

In the invention, the thermosensitive image formation layer containing the latex in the invention provides a planographic printing plate material for CTP system which is excellent in ink receptivity, on-press development property, printing durability, and scratch resistance.

The reason for providing the advantageous effects as described above is not clear, but is considered to be due to the following.

Each of the hydrophilic component as the protective colloid and the hydrophilic component in the latex effectively works in the thermosensitive image formation layer, which is different from a layer containing a simple mixture of the hydrophilic component and the hydrophilic component.

Since the hydrophilic component is coated only on the surface of the hydrophobic component in the latex in the invention, the hydrophilic component is uniformly contained in the thermosensitive image formation layer in an amount smaller than in a layer containing a simple mixture of the hydrophilic component and the hydrophobic component, which results in improvement of printing durability and scratch resistance.

### (Thermosensitive Image Formation Layer)

The thermosensitive image formation layer is a layer capable of forming an image by imagewise heating, which contains thermoplastic materials such as heat-melting materials or heat-fusible materials, or materials (hydrophobic precursors which change from hydrophilic property to oleophilic property by heating. Heating is carried out employing preferably heat generated on actinic ray exposure, and more preferably heat generated on laser exposure.

The thermosensitive image formation layer in the invention is preferably one capable of being subjected to on-press development, wherein the advantageous effects of the invention are enhanced. In the invention, on-press development is to develop an exposed planographic printing plate material on the plate cylinder of a printing press by supplying dampening water or both of dampening water and printing ink to the image formation layer of the exposed planographic printing plate material to remove an image formation layer at non-image portions, whereby a planographic printing plate is obtained. Printing follows the on-press development, employing the planographic printing plate.

The hydrophobic component of the latex in the invention is preferably one capable of forming an image by heating, and is more preferably one comprised of heat-melting materials or heat-fusible materials.

The heat melting particles are particularly particles having a low melt viscosity, which are particles formed from a material (wax material) generally classified into wax. The heat melting particles preferably have a softening point of from 40 to 120° C. and a melting point of from 60 to 150° C., and more preferably a softening point of from 40 to 100° C. and a melting point of from 60 to 120° C. The above range is preferred in storage stability or ink receptivity.

The wax material used in the heat melting particles include paraffin wax, polyolefin wax, polyethylene wax, microcrystalline wax, fatty acid ester wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Among them, polyethylene wax, microcrystalline wax, fatty acid ester wax, and fatty acid wax are preferred. A high sensitive image formation can be performed since these wax materials each have a relative low melting point and a low melt viscosity. These materials each have a lubrication ability. Accordingly, even when a shearing force is applied to the surface layer of the printing plate precursor, the layer damage is minimized, and resistance to stain which may be caused by scratch is further enhanced.

Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

The heat melting particles are preferably dispersible in water. The average particle size thereof is preferably from 0.01 to 10 μm, and more preferably from 0.1 to 3 μm, in view of on-press developability or resolution. The composition of the heat melting particles may be continuously varied from the interior to the surface of the particles. Further, the heat melting particles may be covered with a different material.

The heat fusible particles in the invention include particles of a thermoplastic hydrophobic polymer (hereinafter referred to as hydrophobic polymer). Although there is no specific limitation to the upper limit of the softening point of the hydrophobic polymer, the softening point of the hydrophobic polymer is preferably lower than the decomposition temperature of the polymer.

Examples of the hydrophobic polymer constituting the hydrophobic polymer particles include polypropylene; a diene (co)polymer such as polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); a vinyl ester (co)polymer such as polyvinyl acetate, a vinyl acetate-vinyl propionate copolymer, a vinyl acetate-ethylene copolymer or a vinyl acetate-2-hexylethyl acrylate copolymer; and a (co)polymer of acrylonitrile, vinyl chloride, vinylidene chloride or styrene. Among them, a (meth)acrylate (co)polymer, a (meth)acrylic acid (co)polymer, a vinyl ester (co)polymer, polystyrene and synthetic rubbers are preferably used.

The hydrophobic polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzene sulfonate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm.

The composition of the heat fusible particles may be continuously varied from the interior to the surface of the particles. Further, the particles may be covered with a different material. The particles are preferably in the core-shell form. The core-shell form can improve reactivity of the surface, and can easily control physical properties such as hardness or Tg of the particles. The hydrophobic polymer constituting the hydrophobic polymer particles has a weight average molecular weight of preferably from 500 to 500,000 and a number average molecular weight of preferably from 200 to 600,000.

The hydrophilic component of the latex in the invention is preferably a water-soluble material.

Examples of the water-soluble materials include natural polymers such as gum arabic, water-soluble soybean polysaccharides, cellulose derivatives (such as carboxymethylcellulose, carboxyethylcelluiose, methylcellulose and the like) and their modified products, white dextrin, pullulan, enzymolysis etherified dextrin and gelatin; and synthetic polymers such as polyvinyl alcohol or its derivatives, polyacrylic acid or its derivatives, its alkaline metal or amine salt or their derivatives, polyacrylic acid copolymer or its alkaline metal salt or its amine salt, polymethacrylic acid or its alkaline metal salt or its amine salt, vinyl alcohol-acrylic acid copolymer or its alkaline metal salt or its amine salt, polyacrylamide or its copolymer, polyhydroxyethyl acrylate, polyvinyl pyrrolidone, its copolymer, polyvinyl methyl ether, vinyl methyl ether-maleic acid anhydride copolymer, poly-2-acrylamide-2-methyl-1-propane sulfonic acid or its alkaline metal salt or its amine salt, poly-2-acrylamide-2-methyl-1-propane sulfonic acid copolymer or its alkaline metal salt or its amine salt, and polystyrene sulfonic acid or its derivatives.

Among them, polyvinyl alcohol or its derivatives, polyacrylic acid or its derivatives, or polystyrene sulfonic acid or its derivatives are preferred in view of the effects of the invention.

The content (in terms of solid content) of the latex in the invention is preferably from 3 to 80% by weight, and more preferably from 5 to 60% by weight. The above latex content range is preferred in view of printing durability and scratch resistance.

The content ratio (by weight) of the hydrophobic component to the hydrophilic component in the latex is preferably from 90/10 to 30/70, more preferably from 90/10 to 50/50, and most preferably from 90/10 to 70/30. The above ratio range is preferred in view of printing durability and developability.

The latex in the invention can be prepared according to a conventional synthetic method or a conventional dispersion method. The latex is prepared preferably according to emulsion polymerization. The emulsion polymerization can be carried out by a conventional method, and kinds of a polymerization initiator, a concentration of components used, polymerization temperature or polymerization time can be easily varied in the emulsion polymerization, if necessary. The emulsion polymerization may be carried out by adding a polymerization initiator to a mixture of reaction components, e.g., a monomer, a surfactant, a water-soluble polymer and a medium in a reaction vessel or by dropwise adding all or a part of the amount used of the reaction components into a reaction vessel.

The thermosensitive image formation layer can also contain materials other than those described above.

The thermosensitive image formation layer in the invention can contain the heat melting particles or heat fusible particles as described above, which are not coated by the protective colloid, or water soluble polymers as described above, which do not participate in formation of the latex as described above.

The thermosensitive image formation layer preferably contains an infrared absorbing dye.

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

The infrared absorbing dye content of the thermosensitive image formation layer is preferably from 0.1% by weight to less than 10% by weight, more preferably from 0.3% by weight to less than 7% by weight, and still more preferably from 0.5% by weight to less than 6% by weight, in preventing ablation.

The coating amount of the image formation layer is preferably from 0.01 to 5 g/m², more preferably from 0.1 to 3 g/m, and still more preferably from 0.2 to 2 g/m².

### <Hydrophilic Layer>

In the invention, the image formation layer or hydrophilic layer contains a light-to-heat conversion material, which provides high sensitivity. Particularly, it is preferred that the hydrophilic layer contains the following metal oxides as light-to-heat conversion materials.

As such light-to-heat conversion material, there are materials having black color in the visible regions or materials which are electro-conductive or semi-conductive. Examples of the former include black iron oxide and black complex metal oxides containing at least two metals. Examples of the latter include Sb-doped SnO₂ (ATO), Sn-added In 03 (ITO), TiO₂, TiO prepared by reducing TiO₂ (titanium oxide nitride, generally titanium black). Particles prepared by covering a core material such as BaSO₄, TiO₂, 9AlCO₃.2B₂O and K₂O.nTiO₂ with these metal oxides is usable. These oxides are particles having an average particle size of not more than 0.5 μm, preferably not more than 100 nm, and more preferably not more than 50 nm.

Among these light-to-heat conversion materials, black complex metal oxides containing at least two metals are more preferred.

Examples of the black complex metal oxides containing at least two metals include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide is preferably a Cu—Cr—Mn type complex metal oxide or a Cu—Fe—Mn type complex metal oxide. The Cu—Cr—Mn type complex metal oxides are preferably subjected to the treatment disclosed in Japanese Patent O.P.I. Publication Nos. 8-27393 in order to reduce isolation of a 6-valent chromium ion. These complex metal oxides provide high light heat conversion efficiency relative to the addition amount thereof in the light sensitive layer.

The primary average particle size of these complex metal oxides is preferably from 0.001 to 1.0 μm, and more preferably from 0.01 to 0.5 μm. The primary average particle size of from 0.001 to 1.0 μm improves light heat conversion efficiency relative to the addition amount of the particles, and the primary average particle size of from 0.05 to 0.5 μm further improves light heat conversion efficiency relative to the addition amount of the particles. Light heat conversion efficiency to the addition amount of the particles is greatly influenced by degree of dispersion of the particles. The higher the degree of dispersion of the particles, the higher the light heat conversion efficiency.

Accordingly, these complex metal oxide particles are preferably dispersed according to a known method to prepare a dispersion (paste), which is added to a coating solution. When these complex metal oxide particles are dispersed, a dispersant can be used appropriately. The used amount of the dispersant is preferably from 0.01 to 59 by weight, and more preferably from 0.1 to 2% by weight, based on the weight of complex metal oxide particles.

The content of the complex metal oxide particles in the hydrophilic layer is preferably from 20 to less than 40% by weight, more preferably from 25 to less than 39% by weight, and still more preferably from 25 to less than 30% by weight, based on the total solid content of the hydrophilic layer. The complex metal oxide particle content range above in the hydrophilic layer is preferred in improving sensitivity and in minimizing ablated matter produced on ablation.

In the invention, the image formation layer or hydrophilic layer can contain the following infrared absorbing dye as a light-to-heat conversion material. Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Specifically, there are those disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These may be used singly or in combination.

The infrared absorbing dye content of the hydrophilic layer is preferably from 0.1% by weight to less than 10% by weight, more preferably from 0.3% by weight to less than 7% by weight, and still more preferably from 0.5% by weight to less than 6% by weight, based on the total solid content of hydrophilic layer. The infrared absorbing dye content range above in the hydrophilic layer is preferred in improving sensitivity and in minimizing ablated matter produced on ablation.

It is preferred that the hydrophilic layer in the invention contains a material for forming a hydrophilic matrix as described below in addition to the light-to-heat conversion material described above.

The material for forming the hydrophilic matrix is preferably a metal oxide other than the metal oxide described above, and such a metal oxide is preferably in the form of particles (hereinafter referred to simply as metal oxide particles).

Examples of the metal oxide particles include colloidal silica, alumina sol, titania sol and another metal oxide sol. The metal oxide particles may have any shape such as spherical, needle-like, and feather-like shape. The average particle size of the metal oxide particles is preferably from 3 to 100 nm, and more preferably from 5 to 70 nm. Plural kinds of the metal oxide particles, each having a different size, may be used in combination. The surface of the particles may be subjected to surface treatment.

The metal oxide particles can be used as a binder, utilizing their layer forming ability. The metal oxide particles are suitably used in the hydrophilic layer since they minimize lowering of hydrophilicity of the layer as compared with an organic compound binder.

The content of the metal particle oxide as a binder in the hydrophilic layer is preferably from 20 to 80% by weight, and more preferably from 30 to 70% by weight.

Among the above-mentioned, colloidal silica is particularly preferred. The colloidal silica has a high layer forming ability under a drying condition with a relatively low temperature, and can provide high layer strength.

The colloidal silica is preferably necklace-shaped colloidal silica, colloidal silica particles having an average particle size of not more than 20 nm, or an alkaline colloidal silica.

The necklace shaped colloidal silica is a generic term of an aqueous dispersion system of a spherical silica having a primary particle size of the order of nm. The necklace-shaped colloidal silica means a “pearl necklace-shaped” colloidal silica formed by connecting spherical colloidal silica particles each having a primary particle size of from 10 to 50 μm so as to attain a length of from 50 to 400 nm.

The term of “pearl necklace-shaped” means that the image of connected colloidal silica particles is like to the shape of a pearl necklace. Bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

It is known that the binding force of the colloidal silica particles is become larger with decrease of the particle size. The average particle size of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since porosity of the layer is maintained and the layer strength is further increased.

The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer in the invention can contain porous metal oxide particles having an average particle size less than 1 μm as a porosity-providing agent for forming the hydrophilic matrix. Preferred examples of the porous metal oxide particles include porous silica particles, porous aluminosilicate particles or zeolite particles as described later.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred. The porous aluminosilicate particles can be prepared by the method described in, for example, JP O.P.I. No. 10-71764.

Thus prepared porous aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume.

Examples of the porosity-providing agent include zeolite. Zeolite is a crystalline aluminosilicate, which is a porous material having voids of a regular three dimensional net work structure and having a pore size of 0.3 to 1 nm.

The hydrophilic layer in the invention can contain mineral particles. Examples of the mineral particles include a clay mineral such as kaolinite, halloysite, talc and smectite (for example, montmorillonite, beidellite, hectorite and saponite, vermiculite, mica and chlorite); and layer structural clay mineral particles such as hydrotalcite, and layer structural polysilicates (for example, kanemite, makatite, ilerite, magadiite and kenyte).

Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and vermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

With respect to the size of the planar structural mineral particles, the particles have an average particle size of preferably less than 1 μm, and an average aspect ratio of preferably not less than 50, in a state contained in the layer. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle size greater than the foregoing may produce a non-uniform coated layer, resulting in poor layer strength.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

### (Another Additive)

An aqueous solution of a silicate is also usable as another additive in the hydrophilic layer in the invention. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the inorganic particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

The hydrophilic layer may contain a water-soluble resin or a water dispersible resin. Examples of such a resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable.

A water-soluble surfactant may be added to a coating liquid for the hydrophilic layer in the invention for the purpose of improving the coating ability. A silicon atom-containing surfactant, a fluorine atom-containing surfactant or an acetylene glycol type surfactant is preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

The dry coating amount of the hydrophilic layer is preferably from 0.1 to 20 g/m², and more preferably from 0.5 so 15 g/m², and still more preferably from 1 to 10 g/m².

### (Spherical Silica Particles)

It is preferred that the hydrophilic layer in the invention contain spherical silica particles having an average particle size of from 4.0 to 8.0 μm and a CV of a particle size of from 1 to 10%. The hydrophilic layer, containing the spherical silica particles, can optimize irregularities of the surface of the hydrophilic layer or image formation layer, and can improve visualization, scratch resistance at non-image portions, and resistance of image portions to foreign matter occurring when printing is carried out employing a powdering system or employing printing paper sheets likely to produce powdered paper.

The CV in the invention refers to coefficient of variation, and is a measure showing a relative degree of distribution. The less the value CV is, the less the degree of distribution is. Standard deviation is difficult to evaluate, since it is influenced by scale, while the coefficient of variation, even when values having different units are compared with each other, is easy to evaluate, since it removes influence of scale from standard deviation.

A large number of measurements form generally Gaussian distribution, and coefficient of variation of the measurements is computed from average and standard deviation.

In the invention, coefficient of variation CV (%) of a particle size of particles is represented by the following formula:

Coefficient of variation CV (%) of particle size=(Standard deviation of particle size)×100/(Average particle size of particles)

In the invention, the average particle size of particles and CV of the particle size can be measured through Coulter counter calibrated employing reference particles whose particle size is predetermined.

In the invention, CV of the particle size of the spherical silica particles in the hydrophilic layer is preferably from 1 to 109%, and more preferably from 1 to 5%, in view of printability and scratch resistance.

It is preferred in the invention that the average particle size of the spherical silica particles contained in the hydrophilic layer is from 4.0 to 8.0 μm, in view of printing durability, and scratch resistance.

The spherical silica particle content of the hydrophilic layer in the invention is preferably from 3 to 40% by weight, and more preferably from 5 to 25% by weight, in view of layer fastness, scratch resistance and printability.

In the invention, the two hydrophilic layers, an upper hydrophilic layer and a lower hydrophilic layer can be provided, which is preferred in giving different functions to each layer.

Materials used in both upper and lower hydrophilic layers may be the same. It is preferred in view of layer strength that the lower hydrophilic layer be more non-porous and have a less content of a porosity-providing agent. Further, it is effective in the invention that the lower hydrophilic layer contains a more amount of particles, since it can maintain the spherical silica particles as described above or spherical particles as described below having an average particle size of from 1 to 12 μm.

### (Spherical Particles Having an Average Particle Size of from 1 to 12 μm)

It is preferred in the invention that the hydrophilic layer preferably contains, as particles other than the particles described above, particles (such as inorganic particles or inorganic material-coated particles) having an average particle size of from 1 to 12 μm, preferably from 2 to 10 μm, and more preferably from 3 to 8 μm.

A combined use of the spherical silica particles described above and spherical particles having an average particle size of from 3.0 to 4.0 μm is especially preferred

The content of the particles having an average particle size of from 1 to 12 μm in the hydrophilic layer is preferably from 0.5 to 50% by weight, and more preferably from 3 to 30% by weight, based on the total weight of hydrophilic layer.

The structure or composition of the particles may be porous or non-porous, or inorganic or organic. Examples of inorganic particles include silica, alumina, zirconia, titania, carbon black, graphite, TiO₂, BaSO₄, ZnS, MgCO₃, CaCO₃, ZnO, CaO, WS₂, MoS₂, MgO, SnO₂, Al₂O₃, α-Fe₂O₃, α-FeOOH, SiC, CeO₂, BN, SiN, MoC, BC, WC, titanium carbide, corundum, artificial diamond, garnet, garnet, quartz, silica rock, tripoli, diatomite, and dolomite. Examples of organic particles include polyethylene fine particles, fluororesin particles, guanamine resin particles, acrylic resin particles, silicone resin particles, melamine resin particles, and the like.

As inorganic material-coated particles, there are, for example, particles in which organic particles such as particles of PMMA or polystyrene as core particles are coated with inorganic particles with a particle size smaller that that of the core particles. The particle size of the inorganic particles is preferably from 1/10 to 1/100 of that of the core particles. As the inorganic particles, particles of known metal oxides such silica, alumina, titania and zirconia can be used. Various coating methods can be used, but a dry process is preferred which core particles collide with particles for coating at high speed in air as in a hybridizer to push the particles for coating in the core particle surface and fix, whereby the core particles are coated with the particles for coating.

In the invention, any particles can be used as long as they fall within the scope of the invention. However, porous inorganic particles such as porous silica particles or porous aluminosilicate particles or porous inorganic-coated particles are preferably used in order to prevent sedimentation thereof in the coating solution.

### (Protective Layer)

A protective layer can be provided on the thermosensitive image formation layer.

As materials used in the protective layer, the water-soluble resins described above can be preferably used.

As the protective layer, the overcoat layer disclosed in Japanese Patent O.P.I. Publication Nos. 2002-19318 and 2002-86948 can be preferably used.

The coating amount of the protective layer is from 0.01 to 10 g/m², preferably from 0.1 to 3 g/m², and more preferably from 0.2 to 2 g/m².

### (Support)

As a support of the printing plate material, those conventionally used as supports for printing plates can be used. Examples of such a support include a metal plate, a plastic film, a paper sheet treated with polyolefin, and composite sheets such as laminates thereof. The thickness of the support is not specifically limited as long as a printing plate having the support can be mounted on a printing press, and is advantageously from 50 to 500 μm in easily handling.

Examples of the metal plate include iron, stainless steel, and aluminum. Aluminum or aluminum alloy (hereinafter also referred to as aluminum) is especially preferable in its gravity and stiffness. Aluminum is ordinarily used after degreased with an alkali, an acid or a solvent to remove oil on the surface, which has been used when rolled and wound around a spool. Degreasing is preferably carried out employing an aqueous alkali solution.

The support is preferably subjected to adhesion enhancing treatment or subbing layer coating in order to enhance adhesion of the support to a layer to be coated. There is, for example, a method in which the support is immersed in, or coated with, a solution containing silicate or a coupling agent, and then dried. Anodization treatment is considered to be one kind of the adhesion enhancing treatment and can be employed as such. Further, a combination of the anodization treatment with the immersion or coating as above can be employed. An aluminum plate to have been surface roughened according to a conventional method can be also employed.

Examples of resin for the plastic film include polyethylene terephthalate, polyethylene naphthalate (PEN), polyimide, polyamide, polycarbonate, polysulfone, polyphenylene oxide, and cellulose ester.

Among these, polyester such as PET or PEN is preferred, and PET is especially preferred, in view of handling with ease.

PET is a polycondensate of terephthalic acid and ethylene glycol, and PEN is a polycondensate of naphthalene dicarboxylic acid and ethylene glycol. These polyesters are obtained by condensation polymerization of the respective monomers and optionally one or more kinds of a third component in the presence of appropriate catalysts.

As the third component, there is a compound having a divalent ester-forming functional group capable of forming an ester.

As the dicarboxylic acid, there is, for example, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylthioether dicarboxylic acid, diphenylketone dicarboxylic acid, diphenylindane dicarboxylic acid, and as a diol, there is, for example, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)-sulfone, bisphenolfluorene dihydroxyethyl ether, diethylene glycol, hydroquinone, cyclohexane diol. The third component may be a polycarboxylic acid or a polyol, but the content of the polycarboxylic acid or polyol is preferably from 0.001 to 5% by weight based on the weight of polyester.

The intrinsic viscosity of the resin for the plastic film is preferably from 0.5 to 0.8. Polyesters having different viscosity may be used as a mixture of two or more kinds thereof.

A synthetic method of the polyester in the invention is not specifically limited, and the polyester can be synthesized according to a conventional polycondensation method. As the synthetic method, there is a direct esterification method in which a dicarboxylic acid is directly reacted with a diol or an ester exchange method in which dialkyl ester as a dicarboxylic acid component is reacted with a diol while heating under reduced pressure where produced diol is removed.

In the synthetic method above, an ester exchange catalyst, a polymerization catalyst or a heat-resistant stabilizer can be used. Examples of the heat-resistant stabilizer include Phosphoric acid, phosphorous acid, PO(OH) (CH₃)₃, PO(OH) (OC₆H₅)₃, and P(OC₆H₅)₃. During synthesis of the polyesters, an anti-stain agent, a crystal nucleus agent, a slipping agent, an anti blocking agent, a UV absorber, a viscosity adjusting agent, a transparentizing agent, an anti-static agent, a pH adjusting agent, a dye or pigment may be added.

### (Particles)

Particles having a size of from 0.01 to 10 μm are preferably incorporated in an amount of from 1 to 1000 ppm into the support, in improving handling property.

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Pat. No. 3,079,257 and polycarbonate described in U.S. Pat. No. 3,022,169. The shape of the particles may be in a regular form or irregular form.

The support in the invention has a coefficient of elasticity of preferably from 300 to 800 kg/mm², and more preferably from 400 to 600 kg/mm², in view of improving handling property of the printing plate material of the invention.

The coefficient of elasticity herein referred to is a slope of the straight line portion in the stress-strain diagram showing the relationship between strain and stress, which is obtained employing a tension test meter according to JIS C2318. This slope is called Young's modulus, which is defined in the invention as coefficient of elasticity.

It is preferred that the support in the invention has an average thickness of from 100 to 500 μm, and a thickness distribution of not more than 5%, in that when the planographic printing plate material is mounted on a press, the handling property is improved. It is especially preferred that the support in the invention has an average thickness of from 120 to 300 μm, and a thickness distribution of not more than 2%.

The thickness herein referred to means a value (%) obtained by dividing the difference between the maximum thickness and the minimum thickness by the average thickness and then multiplying the difference by 100.

The thickness distribution of the support is determined according to the following: lines are formed at an interval of 10 cm in both the transverse and longitudinal directions on a 60 cm square polyester film sheet to form 36 small squares. The thickness of the 36 small squares is measured, and the average thickness, maximum thickness and minimum thickness are obtained therefrom.

The support in the invention is preferably a plastic sheet, but may be a composite support in which a plate of a metal (for example, iron, stainless steel or aluminum) or a polyethylene-laminated paper sheet is laminated onto the plastic sheet. The composite support may be one in which the lamination is carried out before any layer is coated on the support, one in which the lamination is carried out after any layer has been coated on the support, or one in which the lamination is carried out immediately before mounted on a printing press. In the invention, a subbing layer is preferably provided between the support and the hydrophilic layer.

The subbing layer is preferably comprised of two layers, a lower subbing layer closer to the support and an upper subbing layer closer to the hydrophilic layer. The lower subbing layer preferably contains a material having strong adhesion to the support, and the upper subbing layer preferably contains a material having strong adhesion to both the lower subbing layer and the hydrophilic layer.

Examples of the material for the lower subbing layer include vinyl polymers, polyesters, and styrene-diolefin copolymers. Among these, vinyl polymers, polyesters and a mixture thereof are preferred. The vinyl polymers and polyesters are preferably modified.

The material for the upper subbing layer is preferably a water soluble polymer in providing improved adhesion to the hydrophilic layer. Examples of the material for the upper subbing layer include gelatin, polyvinyl alcohol, modified polyvinyl alcohol, water soluble acryl resins, and water soluble polyesters. The upper subbing layer preferably contains the water soluble polymers and the material used in the lower subbing layer, in order to provide strong adhesion to both the lower subbing layer and the hydrophilic layer.

When a PET sheet is used as a support, a subbing layer containing polyvinyl alcohol, acryl resin or polyesters is preferably provided on the PET sheet. When an aluminum sheet is used as a support, a subbing layer containing carboxymethylcellulose, polyvinyl alcohol, acryl resin or polyesters is preferably provided on the aluminum sheet.

The subbing layer as described above enhances adhesion between the support and the hydrophilic layer, improving foreign matter resistance or on-press development of the planographic printing plate material.

The inorganic material particles as described below can be employed for the subbing layer. Examples of the inorganic material include silica, alumina, barium sulfate, calcium carbonate, titania, tin oxide, indium oxide, and talc. These particle shapes are not particularly limited, and any shape such as needle-like, spherical, plate-like, or fracture-like shape can be used. The particle size is preferably 0.1-15 μm, more preferably 0.2-10 μm, and still more preferable 0.3-7 μm. The coating amount of the particles in the subbing layer on one side of the support is preferably 0.1-50 mg/m², more preferably 0.2-30 mg/m², and still more preferably 0.3-20 mg/m.

The thickness of the subbing layer is preferably 0.05-0.50 μm in view of transparency and uneven coating (interference unevenness), and more preferably 0.10-0.30 μm.

It is preferred that the subbing layer is formed by coating a subbing layer coating liquid on either one surface or both surfaces of polyester film particularly before completing crystalline orientation during manufacturing of the film, or by coating a subbing layer coating liquid on either one surface or both surfaces of polyester film in on line or off line after manufacturing of the film.

As a coating method of the subbing layer, any conventional coating methods may be employed. It is preferable to apply, singly or in combination, the coating methods such as a kiss coating method, a reverse coating method, a die coating method, a reverse kiss coating method, an offset gravure coating method, a Meyer bar coating method, a roller brush method, a spray coating method, an air-knife coating method, a dip-coating method and a curtain coating method.

It is preferable to provide an antistatic layer on the subbing layer. The antistatic layer is comprised of an antistatic agent and a binder.

A metal oxide is preferably employed as an antistatic agent. Examples of such a metal oxide include ZnO, TiO₂, SnO₂, Al₂O₃, In₂O₃, SiO₂, MgO, BaO, MoO₂, V₂O₅, and compound oxides. Specifically, from the viewpoint of miscibility with a binder, electrical conductivity and transparency, SnO₂ (being tin oxide) is preferred. As a metal oxide containing a different atom, there is, for example, SnO₂ added with Sb, Nb or a halogen atom. The added amount of the different atom is in the range of preferably 0.01-25 mol %, and more preferably 0.1-15 mol %.

### (Imagewise Exposure)

In the invention, it is preferred that the planographic printing plate material is imagewise exposed, employing a laser. A thermal laser is especially preferred as the laser employed.

The imagewise exposure is preferably scanning exposure, which is carried out employing a laser, which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

### (Printing)

In the invention, a conventional printing process, which employs a dampening solution and printing ink, can be applied. It is preferred in the invention that the dampening solution contains no isopropanol or contains isopropanol in an amount of not more than 0.5% by weight based on the weight of water used.

Employing the printing plate material after imagewise exposure, printing is carried out without a special development process. That is, the printing plate material after imagewise exposed with a laser is developed on the plate cylinder of a printing press by supplying dampening water or both of dampening water and printing ink to remove an image formation layer at non-image portions, whereby a printing plate is obtained, and then printing is carried out employing the printing plate.

After the printing plate material is imagewise exposed and mounted on a plate cylinder of a printing press, or after the printing plate material is mounted on the cylinder and then imagewise exposed, a dampening roller or both of a dampening roller and an inking roller are brought into contact with the image formation layer of the resulting printing plate material while rotating the plate cylinder to remove the image formation layer at non-image portions of the printing plate material.

Removal of the image formation layer at non-image portions as described above, so-called, on-press development, will be explained below.

Removal (on-press development) of the image formation layer at non-image portions (unexposed portions) of an exposed printing plate material mounted on the plate cylinder of a printing press, is carried out by bringing a dampening roller or both of a dampening roller and an inking roller into contact with the image formation layer of the exposed printing plate material while rotating the plate cylinder to supply dampening water or both dampening water or a printing ink to the image formation layer.

The on-press development can be carried out, for example by various sequences as described below or another appropriate sequence. The amount of dampening water supplied during on-press development may be adjusted to be greater or smaller than the amount of the dampening water ordinarily supplied in printing, and the adjustment may be carried out stepwise or continuously.

Sequence (1) A dampening roller is brought into contact with the image formation layer of a printing plate material on the plate cylinder while one to several tens of rotations of the plate cylinder are carried out, and then an inking roller brought into contact with the image formation layer while one to tens of rotations of the plate cylinder are carried out. Thereafter, printing is carried out.

Sequence (2) An inking roller is brought into contact with the image formation layer of a printing plate material on the plate cylinder while one to several tens of rotations of the plate cylinder are carried out, and then a dampening roller brought into contact with the image formation layer while one to tens of rotations of the plate cylinder are carried out. Thereafter, printing is carried out.

Sequence (3) An inking roller and a dampening roller are simultaneously brought into contact with the image formation layer of a printing plate material on the plate cylinder while one to several tens of rotations of the plate cylinder are carried out. Thereafter, printing starts.

### EXAMPLES

Next, the present invention will be explained employing examples, but the present invention is not limited thereto. In the examples, “parts” represents “parts by weight”, and “%” represents % by weight, unless otherwise specified.

### (Preparation of Support 1)

### (PET Resin)

Added to 100 parts by weight of dimethyl terephthalate, and 65 parts by weight of ethylene glycol, was 0.05 parts by weight of magnesium acetate anhydrate as an ester exchange catalyst, and an ester exchange reaction was conducted under commonly known practice. To the obtained product, added were 0.05 parts by weight of antimony trioxide and 0.03 parts by weight of trimethyl phosphate ester. Subsequently, subjected to a gradual temperature rise and pressure reduction, polymerization was conducted at 280° C. and at 6.65×10 Pa, to obtain polyethylene terephthalate (PET) resin having an intrinsic viscosity of 0.70. Employing the PET resin as obtained above, biaxially oriented PET film was prepared as described below.

### (Biaxially Oriented PET Film)

The PET resin was palletized and subjected to vacuum drying at 150° C. for 8 hours. After that, the resin was melt-extruded at 285° C. from a T die to form a layer, and the layer was electrostatically impressed on a 30° C. cooling drum while electrostatically impressed, and cooled to solidification, whereby unoriented film was obtained. This unoriented film was stretched at a factor of 3.3 in the longitudinal direction, employing a roll type longitudinal stretching machine. Subsequently, the resulting uniaxially oriented film, using a tenter type transverse stretching machine, was stretched at 90° C. by 50% of the total transverse stretch magnification in the first stretching zone, and then stretched at 100° C. in the second stretching zone so that the total transverse stretch magnification was 3.3. Further, the resulting film was preheated at 70° C. for two seconds, heat-set at 150° C. for five seconds in the first setting zone and at 220° C. for 15 seconds in the second setting zone, and relaxed at 160° C. by 5% in the transverse (width) direction. After passed through the tenter, the film was cooled to room temperature in 60 seconds, released from the clips, slit and wound around a core to obtain a 175 μm thick biaxially oriented PET film. The Tg of this biaxially oriented PET film was 79° C., and the thickness distribution of the film was 2%.

The biaxially oriented PET film as obtained above was subjected to corona discharge treatment at 8 W/m²·min. Subsequently, a subbing layer coating solution a-1 was coated on the surface of the film on the side of a hydrophilic layer to be formed, and dried at 123° C. to form subbing layer A-1 with a dry thickness of 0.8 μm on the surface of the film on the hydrophilic layer side.

The resulting film was subjected to corona discharge treatment at 8 W/m²·min on the subbing layer A-1, was coated with subbing layer coating solution a-2 on the subbing layer A-1, and dried at 123° C. to form subbing layer A-2 with a dry thickness of 0.1 μm on the subbing layer A-1. Thus, support 1 (with a subbing layer on one surface of the film) was obtained.

### (Subbing Layer Coating Solution a-1)

| | |
|---|---|
| Latex of styrene/glycidyl methacrylate/butyl acrylate | 250 g |
| (60/39/1) copolymer (Tg = 75° C.) with a solid content of 30% | |
| Latex of styrene/glycidyl methacrylate/butyl acrylate | 25 g |
| (20/40/40) copolymer (Tg = 20° C.) with a solid content of 30% | |
| Anionic surfactant S-1 (2% by weight) | 30 g |

Water was added to make 1 kg.

### (Subbing Layer Coating Solution a-2)

| | |
|---|---|
| Modified water-soluble polyester solution L-4 described later | 31 g |
| (with a solid content of 23%) | |
| Aqueous 5% solution of EXCEVAL (polyvinyl alcohol/ethylene | 58 g |
| copolymer) RS-2117, produced by Kuraray Co., Ltd. | |
| Anionic surfactant S-1 (2% by weight) | 6 g |
| Hardener H-1 (0.5% by weight) | 100 g |
| Spherical silica matting agent SEAHOSTAR KE-P50 (produced | 10 g |
| by Nippon Shokubai Co., Ltd.) 2% dispersion | |

Distilled water was added to make 1000 ml.

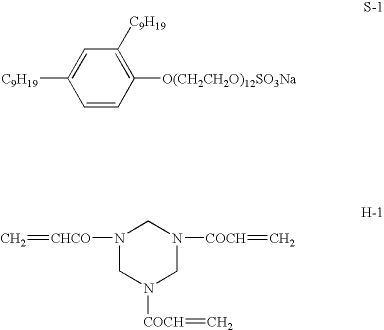

### (Preparation of Modified Water-Soluble Polyester Solution L-4)

A mixture consisting of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 parts by weight of calcium acetate monohydrate, and 0.022 parts by weight of manganese acetate tetrahydrate was subjected to ester exchange reaction at 170 to 220° C. under a flow of nitrogen while distilling out methanol. Thereafter, 0.04 parts by weight of trimethyl phosphate, 0.04 parts by weight of antimony trioxide, and 6.8 parts by weight of 4-cyclohexanedicarboxylic acid were added. The resulting mixture underwent esterification at a reaction temperature of 220 to 235° C. while distilling out a nearly theoretical amount of water. Thereafter, the reaction system was heated over a period of one hour under reduced pressure, and subjected to polycondensation under a maximum pressure of 133 Pa for 1 hour, while heated to a final temperature of 280° C. Thus, water-soluble polyester was prepared. The intrinsic viscosity of the resulting polyester was 0.33, and the weight average molecular weight of the resulting polyester was 80,000 to 100,000.

Subsequently, 850 ml of pure water was placed in a 2-liter three-necked flask fitted with stirring blades, a refluxing cooling pipe, and a thermometer, and 150 g of the water-soluble polyester was gradually added while rotating the stirring blades. The resulting mixture was stirred at room temperature for 30 minutes, heated to 98° C. over a period of 1.5 hours, and maintained at that resulting temperature for 3 hours, whereby dissolution was performed. Thereafter, the mixture was cooled to room temperature over a period of one hour, and allowed to stand overnight, whereby a 15% by weight water-soluble polyester solution A1 was prepared.

One thousand nine hundred milliliters of the foregoing 15% by weight water-soluble polyester solution A1 were placed in a 3-liter four-necked flask fitted with stirring blades, a reflux cooling pipe, a thermometer and a dripping funnel, and heated to 80° C., while rotating the stirring blades. Into this added was 6.52 ml of a 24% aqueous ammonium peroxide solution, and a monomer mixture (consisting of 28.5 g of glycidyl methacrylate, 21.4 g of ethyl acrylate and 21.4 g of methyl methacrylate) was dropwise added over a period of 30 minutes, and the mixture was reacted for additional 3 hours. Thereafter, the reaction mixture was cooled to not more than 30° C., and filtrated. Thus, a modified water-soluble polyester solution B1 having a solid content of 18% by weight was obtained. Herein, the modified water-soluble polyester was an acryl-modified polyester, and the acryl-modified rate in the modified water-soluble polyester was 20% by weight.

Modified water-soluble polyester solution L-4 was prepared in the same manner as above, except that the acryl-modified rate was 5% by weight and the solid content was 23% by weight.

### (Coating of Lower and Upper Hydrophilic Layer Coating Solutions)

A lower hydrophilic layer coating solution prepared as described later was coated on the subbing layer surface of support 1 employing a wire bar, and allowed to pass through a 100° C. drying zone with a length of 15 m at a transportation speed of 15 m/minute to form a lower hydrophilic layer with a dry coating amount of 3.0 g/m².

Subsequently, an upper hydrophilic layer coating solution prepared as described later was coated on the resulting lower hydrophilic layer employing a wire bar, and allowed to pass through a 100° C. drying zone with a length of 30 m at a transportation speed of 15 m/minute to form an upper hydrophilic layer with a dry coating amount of 1.80 g/m².

### (Preparation of Lower Hydrophilic Layer Coating Solution)

A Lower hydrophilic layer coating composition shown in Table 1 was mixed in a homogenizer while stirring, and filtered to prepare a lower hydrophilic layer coating solution.

TABLE 1
(Lower Hydrophilic Layer Coating Composition)

| | Amount |
|---|---|
| Materials | (g) |
| Porous metal oxide: Silton JC-40 (produced by | 8.3 |
| Mizusawa Kagaku Co., Ltd.) | |
| Layer structural clay mineral Montmorillonite: | 26.0 |
| Mineral Colloid MO gel (porous aluminosilicate | |
| particles having an average particle diameter of | |
| 4 μm, produced by Mizusawa Kagaku Co., Ltd.) | |
| prepared by vigorously stirring Montmorillonite | |
| Mineral Colloid MO in water with a homogenizer to | |
| give a solid content of 5% | |
| Cu—Fe—Mn type metal oxide black pigment: | 41.5 |
| TM-3550 black aqueous dispersion (prepared by | |
| dispersing TM-3550 black powder having a particle | |
| diameter of about 0.1 μm produced by Dainichi | |
| Seika Kogyo Co., Ltd. in water to give a solid | |
| content of 40% (including 0.2% by weight of | |
| dispersant) | |
| Carboxymethylcellulose CMC (Reagent produced by | 17.5 |
| Kanto Kagaku Co., Ltd.) 4% aqueous solution | |
| Sodium phosphate•dodecahydrate (Reagent produced | 4.0 |
| by Kanto Kagaku Co., Ltd.) 10% aqueous solution | |
| Colloidal silica: Snowtex-XS (produced by Nissan | 372.9 |
| Chemical Industries, Ltd.) with a solid content | |
| of 20% | |
| Colloidal silica: MP4540M (produced by Nissan | 99.0 |
| Chemical Industries, Ltd.) with a solid content | |
| of 40%) | |
| HIPRESICA (produced by Ube Nitto Kasei Co., Ltd.) | 22.0 |
| Silicon surfactant: FZ2161 (produced by Nippon | 8.8 |
| Unicar Co., Ltd.) with a solid content of 20% | |
| OPTBEADS 3500S (produced by Nissan Chemical | 8.8 |
| Industries, Ltd.) with an average particle size | |
| 3.5 μm | |
| Porous metal oxide: Silton JC-70 (produced by | 11.0 |
| Mizusawa Kagaku Co., Ltd.) | |
| ETB 300 (produced by Titan Kogyo, Ltd.) aqueous | 82.5 |
| dispersion with a solid content of 40% | |
| Pure water | 297.7 |
| Total weight | 1000.0 |

### (Preparation of Upper Hydrophilic Layer Coating Solution)

An upper hydrophilic layer coating composition as shown in Table 2 was mixed in a homogenizer while stirring, and filtered to prepare an upper hydrophilic layer coating solution.

TABLE 2
(Upper Hydrophilic Layer Coating Composition)

| | Amount |
|---|---|
| Materials | (g) |
| ETB 300 (produced by Titan Kogyo, Ltd.) aqueous | 180.0 |
| dispersion with a solid content of 40% | |
| Carboxymeahylcellulose CMC 4% aqueous solution | 1.0 |
| Sodium phosphate•dodecahydrate (Reagent produced by | 1.0 |
| Kanto Kagaku Co., Ltd.) 10% aqueous solution | |
| Colloidal silica: Snowtex-XS (produced by Nissan | 120.0 |
| Chemical Industries, Ltd.) with a solid content of | |
| 30% | |
| Colloidal silica: Snowt ex-PSM (produced by Nissan | 270.0 |
| Chemical Industries, Ltd.) with a solid content of | |
| 20%) | |
| Porous metal oxide particles: Silton AMT-08 | 48.0 |
| (produced by Mizusawa Kagaku Co., Ltd.) with a an | |
| average particle size of 0.8 μm | |
| Colloidal silica: MP4540M (produced by Nissan | 30.0 |
| Chemical Industries, Ltd.) with a solid content of | |
| 40% | |
| Porous metal oxide: Silton JC-20 (produced by | 12.0 |
| Mizusawa Kagaku Co., Ltd.) | |
| Aqueous 2.0% solution of Infrared absorbing dye | 180.0 |
| ADS830WS (produced by American Dye Source Co., | |
| Ltd.) | |
| Pure water | 158.0 |
| Total weight | 1000.0 |

### (Preparation of Image Formation Layer Coating Solution)

An image formation layer coating composition as shown in Table 3 was mixed in a stirrer while stirring, and filtered to prepare an image formation layer coating solution.

### (Preparation of Planographic Printing Plate Material Samples)

The image formation layer coating solution obtained above was coated onto the above-mentioned upper hydrophilic layer employing a wire bar, and allowed to pass through a 70° C. drying zone with a length of 30 m at a transportation speed of 15 m/minute to form a thermosensitive image formation layer with a dry coating amount of 0.55 g/m². The resulting sample was further subjected to aging treatment at 50° C. for 2 days. Thus, a planographic printing plate material sample was prepared.

The resulting planographic printing plate material sample obtained above was cut into a width of 660 mm, and wound 30 m around a paper core having an outer diameter of 76 mm to form a planographic printing plate material sample 1 in the roll form. Planographic printing plate material sample 2 was prepared in the same manner as in planographic printing plate material sample 1, except that 67% by weight of each of A-118, A-206, A0514 and DL522 were substituted with Latex A described later in the same solid content. Planographic printing plate material sample 3 was prepared in the same manner as in planographic printing plate material sample 2, except that Latex B described later was used instead of Latex A. Planographic printing plate material sample 4 was prepared in the same manner as in planographic printing plate material sample 2, except that Latex C described later was used instead of latex A. Planographic printing plate material sample 5 was prepared in the same manner as in planographic printing plate material sample 1, except that 33% by weight of each of A-118, A-206, A0514 and DL522 were substituted with Latex C in the same solid content.

TABLE 3
(Image Formation Layer Coating Composition)

| | Amount |
|---|---|
| Materials | (g) |
| Carnauba wax emulsion: A118 (having an average | 69.1 |
| particle diameter of 0.3 μm, a melting point of | |
| 80° C., and a solid content of 40%, produced by | |
| GIFU SHELLAC CO., LTD.) | |
| Microcrystalline wax emulsion: A206 (having an | 25.2 |
| average particle diameter of 0.5 μm and a solid | |
| content of 40%, produced by GIFU SHELLAC CO., | |
| LTD.) | |
| Polyethylene wax emulsion: A514 (having an | 82.0 |
| average particle diameter of 0.6 μm, a melting | |
| point of 113° C., a molecular weight of 1,000 and | |
| a solid content of 40%, produced by GIFU SHELLAC | |
| CO., LTD.) | |
| *2.0% IPA solution of Infrared absorbing dye | 82.0 |
| ADS830AT (produced by American Dye Source Co., | |
| Ltd.) | |
| Penon JE-66 (having a solid content of 10%, | 16.4 |
| produced by Nippon Starch Chemical Co., Ltd.) | |
| Sodium polyacrylate aqueous solution obtained by | 273.3 |
| diluting DL522 (having a molecular weight of | |
| 170,000 and a solid content of 30%, produced by | |
| Nippon Shokubai Co., Ltd.) with water by a | |
| factor of 10 | |
| Pure water | 452.0 |
| Total weight | 1000.0 |

### (Evaluation)

### Exposure

Each of the resulting printing plate material samples was cut so as to suit an exposure device, wound around an exposure drum of the exposure device and imagewise exposed. Exposure was carried out employing laser having a wavelength of 830 nm and a laser beam spot diameter of 18 μm at a resolution of 2,400 dpi with exposure energy of 240 mJ/cm² to form an image with a screen number of 175 lines (The term, “dpi” shows the number of dots per 2.54 cm.). Thus, exposed printing plate material samples were obtained.

### Printing Method

Each of the exposed printing plate material samples was mounted on a plate cylinder of a printing press, and printing was carried out supplying printing ink and dampening water to the printing plate material sample. When images were printed on a fresh printing paper sheet, powder (Trade name: Nikkalyco M, produced by Nikka Ltd.) was sprayed onto the fresh printing sheet at a printing press powder scale of 10. The printing press, dampening water, printing ink, and printing paper sheets used were as follows:

### Printing Press: DAIYA 1-F produced by Mitsubishi Jukogyo Co., Ltd.

Dampening water: 2% by weight of Astromark 3 (produced by Nikken Kagaku Kenkyusho)
Printing ink: Toyo Hyunity Magenta (produced by Toyo Ink Manufacturing Co.)

### Printing Paper Sheets:

i) Coated paper sheets (which were used when evaluations except for printing durability were carried out.)
ii) Woodfree paper sheets (which were used when printing durability was evaluated)

### (On-Press Development Property)

Printing was carried out according to the printing conditions described above, and the number of printed copies consumed from when printing started until when a print having an excellent S/N ratio was obtained was determined as a measure of on-press development property. The print having an excellent S/N ratio refers to one in which no background contamination was observed at non-image portions, showing that an image formation layer at non-image portions was completely removed on the press, and image density at image portions was in an appropriate range. The less the number is, the better the on-press development property. The number not less than 40 is practically problematic.

### (Printing Durability)

Printing was carried out to print on the other surface of woodfree paper sheets with a printed image on one surface thereof, and terminated when either lack of 3% small dots in an image or lowered density at solid range portions was confirmed. The nuclear of printed copies printed until the printing termination was determined as a measure of printing durability.

### (Scratch Resistance, Stain Resistance)

The image formation layer surface of the samples before exposure was rubbed by using the nail portion of an index finger, and the actual damage level at the non-image portions of 20^{th} printed paper sheet was determined according to the following criteria, and was evaluated as a measure of scratch resistance.

### A: No ink contamination was observed

### B: Slight ink contamination was observed.

### C: Some ink contamination was observed.

### D: Ink contamination with the same density as at 50% dot image portions was observed.

### E: Ink contamination with the same density as at solid image portions was observed.

The results are shown in Table 4.

### Preparation of Latex A

Forty-five parts of water were placed in a reaction vessel fitted with stirring blades, a reflux condenser, a thermometer and a dripping funnel, and heated to 80° C. Into this added were 0.3 parts of a 25% aqueous solution of a surfactant ADEKA REASOAP SE1025N (produced by Asahi Denka Kogyo Co., Ltd.) and 0.3 parts of a 25% ammonium persulfate aqueous solution.

After five minutes, an emulsion, which was obtained by emulsifying, in a homogenizer, a mixture of 2 parts of methyl methacrylate, 1.7 parts of butyl acrylate, 1 part of acrylic acid, 0.8 parts of a 25% ADEKA REASOAP SE1025N aqueous solution, 1 part of a 2% ammonium persulfate aqueous solution and 10 parts of water, and a polyvinyl alcohol solution, in which 2 parts of polyvinyl alcohol Kuraray Poval PVA117® with a saponification degree of 99% and a polymerization degree of 1700 (reduced by Kuraray Co., Ltd.) was dissolved in 160 parts of water, were dropwise added to the resulting solution over a period of 4 hours, while the solution was maintained at 80° C. After that, the resulting reaction solution was allowed to stand at 80° C. for additional one hour, and then cooled to 50° C. and stored at 50° C. to prepare Latex A containing polyvinyl alcohol as a protective colloid. Latex A had a solid content of 16% and contained latex particles with a number average particle size of 130 nm. The ratio by weight of resin to water-soluble resin (resin/water soluble resin) in Latex A was 70/30.

### Preparation of Latex B

Carnauba wax emulsion A118, Microcrystalline wax emulsion A206, and Polyethylene wax emulsion A514 were added in the same content ratio as those in the image formation layer coating composition shown in Table 3 to a solution in which ossein gelatin with an average molecular weight of 100,000 had been dissolved in water. The resulting mixture was heated to a temperature of from 100 to 150° C. and stirred in an ordinary pressure homomixer T.K Homomixer (produced by Tokushu Kika Kogyo Co., Ltd.) to obtain a pre-emulsion. The resulting pre-emulsion was homogenized in a high-pressure homogenizer LA 31 TYPE (produced by Nanomizer Co., Ltd.) at a pressure of 1,300 kg/cm² to prepare Latex B containing gelatin as a protective colloid. The ratio by weight of wax to water-soluble resin (wax/water soluble resin) in Latex B latex was 70/30.

### Preparation of Latex C

Latex C, containing sodium polyacrylate as a protective colloid, was prepared in the same manner as in Latex A above, except that sodium polyacrylate DL522 was used instead of polyvinyl alcohol.

TABLE 4

| | Latex used in | | | | | |
|---|---|---|---|---|---|---|
| | Image Formation | | | | | |
| | Layer | | | | | |
| | | Substitution | On-press | Printing | Scratch | |
| Sample | | Percentage | Development | Dura- | Re- | Re- |
| No. | Kind | (by weight) | Property | bility | sistance | marks |
| 1 | None | 0 | 16 | 7 | D | Comp. |
| 2 | A | 67 | 12 | 13 | A | Inv. |
| 3 | B | 67 | 10 | 11 | B | Inv. |
| 4 | C | 67 | 7 | 13 | A | Inv. |
| 5 | C | 33 | 6 | 18 | A | Inv. |

As is apparent from Table 4, inventive planographic printing plate material samples provide excellent on-press development property, printing durability, and scratch resistance.

What is claimed is:

1. A planographic printing plate material comprising a support and provided thereon, a hydrophilic layer containing a light-to-heat conversion material and a thermosensitive image formation layer in that order, wherein the thermosensitive image formation layer contains a latex containing a hydrophobic component and a hydrophilic component as a protective colloid.

2. The planographic printing plate material of claim 1, wherein the hydrophobic component is comprised of heat melting particles or heat fusible particles.

3. The planographic printing plate material of claim 2, wherein the hydrophobic component is comprised of the heat melting particles, which are formed from a wax material having a softening point of from 40° C. to 120° C. and a melting point of from 60° C. to 150° C.

4. The planographic printing plate material of claim 3, wherein the wax material is selected from the group consisting of polyethylene wax, microcrystalline wax, fatty acid ester wax and fatty acid wax.

5. The planographic printing plate material of claim 2, wherein the hydrophobic component is comprised of the heat melting particles, which are formed from a hydrophobic polymer having a weight average molecular weight of from 500 to 500,000 and a number average molecular weight of from 200 to 60,000.

6. The planographic printing plate material of claim 5, wherein the hydrophobic polymer is selected from the group consisting of (meth)acrylate (co)polymer, (meth)acrylic acid (co)polymer, vinyl ester (co)polymer, polystyrene and the synthetic rubbers.

7. The planographic printing plate material of claim 1, wherein the hydrophilic component as a protective colloid is selected from the group consisting of polyvinyl alcohol and its derivatives, polyacrylic acid and its derivatives, polystyrene sulfonic acid and its derivatives, and gelatin.

8. The planographic printing plate material of claim 1, wherein the content ratio (by weight) of the hydrophobic component to the hydrophilic component in the latex is from 90/10 to 50/50.

9. The planographic printing plate material of claim 1, wherein the thermosensitive image formation layer contains an infrared absorbing dye.

10. A printing process comprising the steps of:
a) imagewise exposing the planographic printing plate material of claim 1, employing a laser; and
b) developing the exposed planographic printing plate material on the plate cylinder of a printing press by supplying dampening water or both dampening water and an printing ink to the exposed planographic printing plate material to prepare a planographic printing plate, followed by printing.
